(19) United States
(12) Patent Application Publication
(10) Pub. No.: US 2025/0275029 A1
(43) Pub. Date: Aug. 28, 2025

(54) LIGHTING DEVICE DRIVING POWER SUPPLY CAPABLE OF FORMING DUAL CLOSED LOOPS

(71) Applicant: Xiamen PVTECH Co., Ltd., Xiamen (CN)

(72) Inventors: ZHIRONG LIN, Xiamen (CN); Fuxing Lu, Xiamen (CN)

(73) Assignee: Xiamen PVTECH Co., Ltd., Xiamen (CN)

(21) Appl. No.: 19/059,202

(22) Filed: Feb. 20, 2025

(30) Foreign Application Priority Data
Feb. 23, 2024 (CN) 202410206112.6

(51) Int. Cl. H05B 45/30

(52) U.S. Cl. CPC H05B 45/30

(57) ABSTRACT

A lighting device driving power supply includes: a rectification module connected to a power grid; a first energy storage module connected to the rectification module; a second energy storage module connected to the rectification module, the first energy storage module, and a light source; a switch module connected to the rectification module, the first energy storage module, and the second energy storage module; a third energy storage module is connected to the first energy storage module, the second energy storage module, the switch module, and the light source. When the switch module is turned on, the rectification module charges the first, second, and third energy storage modules. When the switch module is turned off, the first energy storage module and the second energy storage module form a first closed loop, while the third energy storage module and the light source form a second closed loop.

### BACKGROUND OF THE INVENTION

### 1. Field of the Invention

The present invention relates to a driving power supply, in particular to a lighting device driving power supply capable of forming dual closed loops.

### 2. Description of the Prior Art

With advancements in technology, lighting devices have undergone significant improvements, and the market demand for lighting devices with anti-flicker function has been steadily increasing. To achieve flicker-free lighting, currently available low power factor driving power supplies can meet the flicker-free requirements but cause severe harmonic distortion, polluting the power grid and potentially interfering with other devices. Driving power supplies with high power factor and anti-flicker function can achieve both flicker-free performance and a high power factor, but these devices suffer from low efficiency, and the light output fluctuates when the power grid experiences voltage variations. Driving power supplies equipped with power factor correction circuits and DC/DC conversion circuits can address the above problems, but these devices are costly. Similarly, driving power supplies with valley-fill circuits can also resolve these issues, but the power factor of these devices fails to meet requirements under wide voltage applications.

### SUMMARY OF THE INVENTION

One embodiment of the present invention provides a lighting device driving power supply capable of forming dual closed loops, which includes a rectification module, a first energy storage module, a second energy storage module, a switch module and a third energy storage module. The rectification module is connected to a power grid. The first energy storage module is connected to the rectification module. The second energy storage module is connected to the rectification module, the first energy storage module, and a light source. The switch module is connected to the rectification module, the first energy storage module, and the second energy storage module. The third energy storage module is connected to the first energy storage module, the second energy storage module, the switch module, and the light source. When the switch module is turned on, the rectification module receives an input voltage from the power grid to output a rectified voltage to drive the light source and charge the first energy storage module, the second energy storage module, and the third energy storage module. When the switch module is turned off, the first energy storage module and the second energy storage module form a first closed loop, while the third energy storage module and the light source form a second closed loop.

In one embodiment, when the switch module is turned off, the first energy storage module discharges to generate a first current, and the first current charges the second energy storage module and forms the first closed loop. The third energy storage module discharges to generate a second current, and the second current passes through the light source and forms the second closed loop.

In one embodiment, the first energy storage module includes a first inductor.

In one embodiment, the second energy storage module includes a first capacitor.

In one embodiment, the third energy storage module includes a second inductor.

In one embodiment, the light source is a light-emitting diode (LED) or a LED array.

In one embodiment, the lighting device driving power supply further comprising a voltage stabilization module connected to the light source in parallel.

In one embodiment, the voltage stabilization module includes a second capacitor.

In one embodiment, the switch module is a metal-oxide-semiconductor field-effect transistor (MOSFET) or a bipolar junction transistor (BJT).

In one embodiment, the rectification module is a bridge rectifier.

The lighting device driving power supply capable of forming dual closed loops in accordance with the embodiments of the present invention may have the following advantages:
(1) In one embodiment of the present invention, the lighting device driving power supply includes a rectification module, a first energy storage module, a second energy storage module, a switch module and a third energy storage module. The rectification module is connected to a power grid. The first energy storage module is connected to the rectification module. The second energy storage module is connected to the rectification module, the first energy storage module, and a light source. The switch module is connected to the rectification module, the first energy storage module, and the second energy storage module. The third energy storage module is connected to the first energy storage module, the second energy storage module, the switch module, and the light source. When the switch module is turned on, the rectification module receives an input voltage from the power grid to output a rectified voltage to drive the light source and charge the first energy storage module, the second energy storage module, and the third energy storage module. When the switch module is turned off, the first energy storage module and the second energy storage module form a first closed loop, while the third energy storage module and the light source form a second closed loop. Via this dual closed-loop mechanism, the driving power supply charges the second energy storage module via the first closed loop when the switch module is turned off and drives the light source via the second closed loop. Thus, the rectification module can remain in on state even when the switch module is turned off, such that the lighting device driving power supply can achieve a high power factor. Additionally, this mechanism effectively prevents increased harmonic currents, thus avoiding pollution of the power grid.
(2) In one embodiment of the present invention, the lighting device driving power supply charges the second energy storage module via the first closed loop when the switch module is turned off. In this way, the second energy storage module can effectively prevent voltage surges caused by sudden changes in the input voltage. Consequently, the lighting device driving power supply prevents light source flicker caused by voltage surges. Thus, the lighting device driving power supply can provide anti-flicker function and achieve high efficiency.
(3) In one embodiment of the present invention, the driving power supply charges the second energy storage module via the first closed loop when the switch module is turned off. Therefore, the second energy storage module can effectively prevent voltage surges caused by sudden changes in the input voltage. As a result, the lighting device driving power supply meets the requirements for wide voltage input, such that the lighting device driving power supply can be more comprehensive in application and meet the requirements of different applications.
(4) In one embodiment of the present invention, the lighting device driving power supply can be realized via simple circuit design without the need for costly controllers or other specialized circuit components. As a result, the cost of the lighting device driving power supply is significantly reduced while maintaining excellent performance. Therefore, the lighting device driving power supply can conform to actual requirements.
(5) In one embodiment of the present invention, the lighting device driving power supply is designed with simplicity, achieving the desired performance while reducing costs. This simplicity ensures high practicality, meeting the diverse needs of different users and aligning with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a circuit structure of a lighting device driving power supply capable of forming dual closed loops in accordance with one embodiment of the present invention.

FIG. 2 is a circuit diagram of the lighting device driving power supply capable of forming dual closed loops in accordance with one embodiment of the present invention.

FIG. 3 is a first schematic view of an operating state of the lighting device driving power supply capable of forming dual closed loops in accordance with one embodiment of the present invention.

FIG. 4 is a second schematic view of the operating state of the lighting device driving power supply capable of forming dual closed loops in accordance with one embodiment of the present invention.

FIG. 5 is a block diagram of a circuit structure of a lighting device driving power supply capable of forming dual closed loops in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

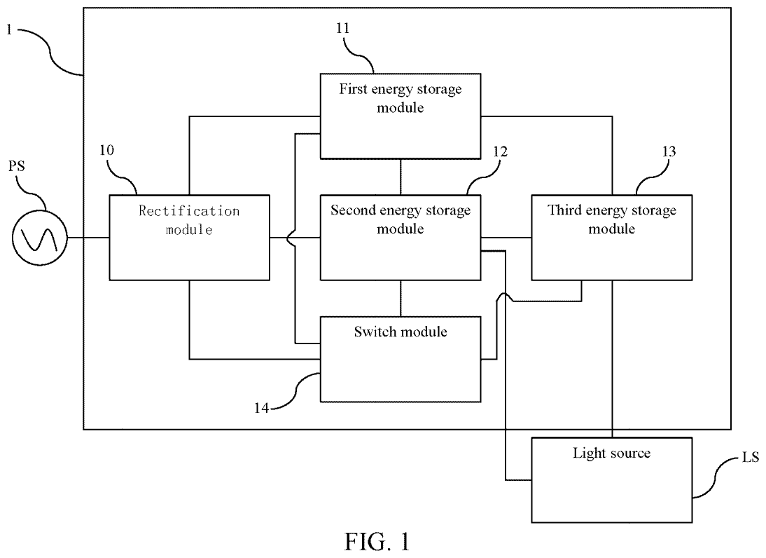

Please refer to FIG. 1, which is a block diagram of a circuit structure of a lighting device driving power supply capable of forming dual closed loops in accordance with one embodiment of the present invention. As shown in FIG. 1, the lighting device driving power supply 1 includes a rectification module 10, a first energy storage module 11, a second energy storage module 12, a switch module 14, and a third energy storage module 13.

The rectification module 10 is connected to a power grid PS. In one embodiment, the rectification module 10 is a bridge rectifier, such as a full-wave rectifier, half-wave rectifier, or other similar components. In one embodiment, the power grid PS may be a utility power. In another embodiment, the power grid PS may be a generator or another power source capable of generating AC input voltage.

The first energy storage module 11 is connected to the rectification module 10. In one embodiment, the first energy storage module 11 may include an inductor. In another embodiment, the first energy storage module 11 may include a capacitor or other components with energy storage capabilities.

The second energy storage module 12 is connected to the rectification module 10, the first energy storage module 11, and the light source LS. In one embodiment, the second energy storage module 12 may include a capacitor. In another embodiment, the second energy storage module 12 may include an inductor or other components with energy storage capabilities. In one embodiment, the light source LS includes one or more light-emitting diodes (LED). In another embodiment, light source LS may include one or more LED arrays.

The switch module 14 is connected to the rectification module 10, the first energy storage module 11, and the second energy storage module 12. In one embodiment, the switch module 14 is a metal-oxide-semiconductor field-effect transistor (MOSFET). In another embodiment, the switch module 14 may be a bipolar junction transistor (BJT) or other similar components.

The third energy storage module 13 is connected to the first energy storage module 11, the second energy storage module 12, the switch module 14, and the light source LS. In one embodiment, the third energy storage module 13 may include an inductor. In another embodiment, the third energy storage module 13 may include a capacitor or other components with energy storage capabilities.

When the switch module 14 is turned on, the rectification module 10 charges the first energy storage module 11, the second energy storage module 12, and the third energy storage module 13.

When the switch module 14 is turned off, the first energy storage module 11 and the second energy storage module 12 form the first closed loop, while the third energy storage module 13 and the light source LS form the second closed loop. First energy storage module 11 discharges to generate the first current to charge the second energy storage module 12 so as to form a first closed loop. The third energy storage module 13 discharges to generate the second current, and the second current flows through the light source LS and forms a second closed loop.

Via the above dual closed-loop mechanism, the lighting device driving power supply 1 charges the second energy storage module 12 via the first closed loop when switch module 14 is turned off and drives the light source LS via the second closed loop. In this way, the rectification module 10 can remain in on state even when the switch module 14 is turned off, such that the lighting device driving power supply 1 can maintain a high power factor. Additionally, this mechanism effectively prevents increased harmonic currents, thereby avoiding pollution of the power grid.

Furthermore, the lighting device driving power supply 1 charges the second energy storage module 12 via the first closed loop when the switch module 14 is turned off. Thus, the second energy storage module 12 can effectively prevent voltage surges caused by sudden changes in the input voltage. Consequently, the lighting device driving power supply 1 effectively prevents flicker in light source LS caused by voltage surges. Thus, the lighting device driving power supply 1 can provide anti-flicker function and achieve high efficiency.

The embodiment just exemplifies the present invention and is not intended to limit the scope of the present invention; any equivalent modification and variation according to the spirit of the present invention is to be also included within the scope of the following claims and their equivalents.

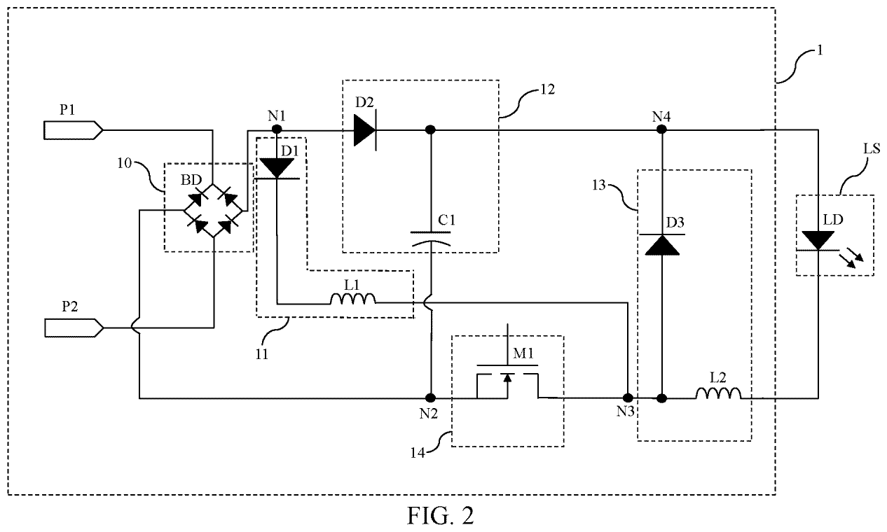

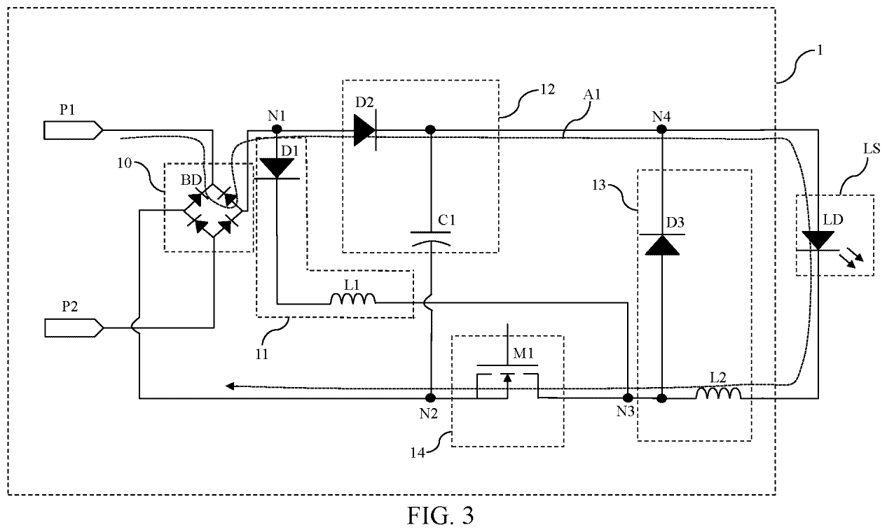

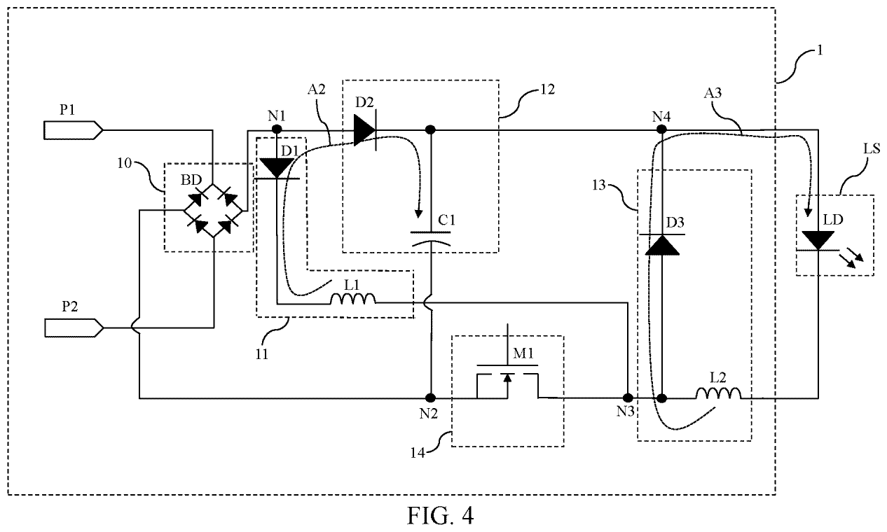

Please refer to FIG. 2, FIG. 3, and FIG. 4. FIG. 2 is a circuit diagram of the lighting device driving power supply capable of forming dual closed loops in accordance with one embodiment of the present invention. FIG. 3 is a first schematic view of an operating state of the lighting device driving power supply capable of forming dual closed loops in accordance with one embodiment of the present invention. FIG. 4 is a second schematic view of the operating state of the lighting device driving power supply capable of forming dual closed loops in accordance with one embodiment of the present invention. FIG. 2 illustrates a possible circuit design for the lighting device driving power supply 1. However, the circuit design of lighting device driving power supply 1 can be modified according to actual requirements, and the present invention is not limited to this design. As shown in FIG. 2, the lighting device driving power supply 1 includes a first terminal P1, a second terminal P2, a rectification module 10, a first energy storage module 11, a second energy storage module 12, a switch module 14, and a third energy storage module 13.

The first terminal P1 and the second terminal P2 are connected to the power grid. The rectification module 10 is a full-wave rectifier BD. The two input ends of the full-wave rectifier BD are connected to the first terminal P1 and the second terminal P2, respectively, while the two output ends of the full-wave rectifier BD are connected to a first node N1 and a second node N2, respectively.

The first energy storage module 11 is connected to the rectification module 10. The first energy storage module 11 includes a first inductor L1 and a first diode D1. The anode of the first diode D1 is connected to the first node N1, and the cathode of the first diode D1 is connected to one end of the first inductor L1. The other end of the first inductor L1 is connected to a third node N3.

The second energy storage module 12 is connected to the rectification module 10, the first energy storage module 11, and the light source LS. The second energy storage module 12 includes a first capacitor C1 and a second diode D2. The anode of the second diode D2 is connected to the first node N1, and the cathode of the second diode D2 is connected to one end of the first capacitor C1 and the fourth node N4. The other end of the first capacitor C1 is connected to the second node N2.

The switch module 14 is connected to the rectification module 10, the first energy storage module 11, and the second energy storage module 12. The switch module 14 is a transistor M1 (MOSFET). The source of transistor M1 is connected to the second node N2, and the drain of transistor M1 is connected to the third node N3.

The third energy storage module 13 is connected to the first energy storage module 11, the second energy storage module 12, the switch module 14, and the light source LS. The third energy storage module 13 includes a second inductor L2 and a third diode D3. The cathode of the third diode D3 is connected to the fourth node N4, and the anode of the third diode D3 is connected to the third node N3 and one end of the second inductor L2.

The light source LS includes a light-emitting diode LD. The anode of the light-emitting diode LD is connected to the fourth node N4, and the cathode of the light-emitting diode LD is connected to the other end of the second inductor L2.

The embodiment just exemplifies the present invention and is not intended to limit the scope of the present invention; any equivalent modification and variation according to the spirit of the present invention is to be also included within the scope of the following claims and their equivalents.

As shown in FIG. 3, the rectification module 10 receives the input voltage from the power grid to output a rectified voltage and generate a driving current to drive the light source LD. When the transistor M1 is turned on, the driving current flows through the second diode D2, the light-emitting diode LD, the second inductor L2, the transistor M1, and the full-wave rectifier BD back to the power grid. At the same time, the second inductor L2 stores energy from the driving current. The direction of the current is shown by the arrow A1 of FIG. 3.

The embodiment just exemplifies the present invention and is not intended to limit the scope of the present invention; any equivalent modification and variation according to the spirit of the present invention is to be also included within the scope of the following claims and their equivalents.

As shown in FIG. 4, when the transistor M1 is turned off, the first inductor L1 discharges to generate the first current, and the first current charges the first capacitor C1 and forms the first closed loop. The direction of the current is shown by the arrow A2 of FIG. 4. Since the voltage across the first capacitor C1 does not change abruptly, this prevents the light-emitting diode LD from flickering due to voltage surges, thereby providing anti-flicker function. The first closed loop keeps the full-wave rectifier BD in on state in order to ensure continuous current flow, achieve a high power factor, and avoid increased harmonic currents.

In addition, the second inductor L2 discharges to generate the second current, which flows through the light-emitting diode LD and forms the second closed loop, thereby driving the light-emitting diode LD. The direction of the current is shown by the arrow A3 of FIG. 4.

Via this dual closed-loop mechanism, the lighting device driving power supply 1 charges the second energy storage module 12 via the first closed loop when the switch module 14 is turned off and drives the light source LS via the second closed loop. In this way, the rectification module 10 can remain in on state even when the switch module 14 is turned off, such that the lighting device driving power supply 1 can maintain a high power factor. Additionally, this mechanism effectively prevents increased harmonic currents, thereby avoiding pollution of the power grid.

Furthermore, the lighting device driving power supply 1 charges the second energy storage module 12 via the first closed loop when the switch module 14 is turned off, such that the second energy storage module 12 can effectively prevent voltage surges caused by sudden changes in the input voltage. Consequently, the lighting device driving power supply 1 effectively prevents flicker in the light source LS caused by voltage surges. Thus, the lighting device driving power supply 1 can provide anti-flicker function, and achieve high efficiency.

Moreover, the lighting device driving power supply 1 charges the second energy storage module 12 via the first closed loop when the switch module 14 is turned off, ensuring the second energy storage module 12 effectively prevents voltage surges caused by sudden changes in the input voltage. This enables the lighting device driving power supply 1 to meet the requirements for wide voltage input. As a result, the lighting device driving power supply 1 can be more comprehensive in application and meet the requirements of different applications.

As set forth above, the lighting device driving power supply 1 can be implemented with a simple circuit design without requiring costly controllers or other specialized circuit components. This significantly reduces the cost of the lighting device driving power supply 1 while achieving excellent performance. Therefore, the lighting device driving power supply 1 can meet actual requirements.

The embodiment just exemplifies the present invention and is not intended to limit the scope of the present invention; any equivalent modification and variation according to the spirit of the present invention is to be also included within the scope of the following claims and their equivalents.

It is worthy to point out that currently available low power factor driving power supplies can meet the flicker-free requirements but cause severe harmonic distortion, polluting the power grid and potentially interfering with other devices. Driving power supplies with high power factor and anti-flicker function can achieve both flicker-free performance and a high power factor, but these devices suffer from low efficiency, and the light output fluctuates when the power grid experiences voltage variations. Driving power supplies equipped with power factor correction circuits and DC/DC conversion circuits can address the above problems, but these devices are costly. Similarly, driving power supplies with valley-fill circuits can also resolve these issues, but the power factor of these devices fails to meet requirements under wide voltage applications. By contrast, according to one embodiment of the present invention, the lighting device driving power supply includes a rectification module, a first energy storage module, a second energy storage module, a switch module and a third energy storage module. The rectification module is connected to a power grid. The first energy storage module is connected to the rectification module. The second energy storage module is connected to the rectification module, the first energy storage module, and a light source. The switch module is connected to the rectification module, the first energy storage module, and the second energy storage module. The third energy storage module is connected to the first energy storage module, the second energy storage module, the switch module, and the light source. When the switch module is turned on, the rectification module receives an input voltage from the power grid to output a rectified voltage to drive the light source and charge the first energy storage module, the second energy storage module, and the third energy storage module. When the switch module is turned off, the first energy storage module and the second energy storage module form a first closed loop, while the third energy storage module and the light source form a second closed loop. Via this dual closed-loop mechanism, the driving power supply charges the second energy storage module via the first closed loop when the switch module is turned off and drives the light source via the second closed loop. Thus, the rectification module can remain in on state even when the switch module is turned off, such that the lighting device driving power supply can achieve a high power factor. Additionally, mechanism effectively prevents increased harmonic currents, thus avoiding pollution of the power grid.

Also, according to one embodiment of the present invention, the lighting device driving power supply charges the second energy storage module via the first closed loop when the switch module is turned off. In this way, the second energy storage module can effectively prevent voltage surges caused by sudden changes in the input voltage. Consequently, the lighting device driving power supply prevents light source flicker caused by voltage surges. Thus, the lighting device driving power supply can provide anti-flicker function and achieve high efficiency.

Further, according to one embodiment of the present invention, the driving power supply charges the second energy storage module via the first closed loop when the switch module is turned off. Therefore, the second energy storage module can effectively prevent voltage surges caused by sudden changes in the input voltage. As a result, the lighting device driving power supply meets the requirements for wide voltage input, such that the lighting device driving power supply can be more comprehensive in application and meet the requirements of different applications.

Moreover, according to one embodiment of the present invention, the lighting device driving power supply can be realized via simple circuit design without the need for costly controllers or other specialized circuit components. As a result, the cost of the lighting device driving power supply is significantly reduced while maintaining excellent performance. Therefore, the lighting device driving power supply can conform to actual requirements.

Furthermore, according to one embodiment of the present invention, the lighting device driving power supply is designed with simplicity, achieving the desired performance while reducing costs. This simplicity ensures high practicality, meeting the diverse needs of different users and aligning with future development trends. As described above, the lighting device driving power supply capable of forming dual closed loops according to the embodiments of the present invention can achieve great technical effects.

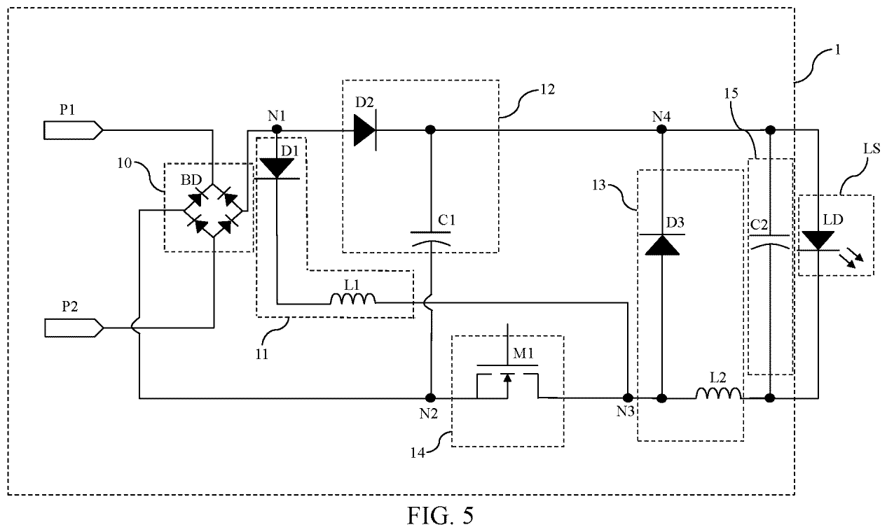

Please refer to FIG. 5, which is a block diagram of a circuit structure of a lighting device driving power supply capable of forming dual closed loops in accordance with another embodiment of the present invention. FIG. 5 illustrates another possible circuit design for the lighting device driving power supply 1. However, the circuit design of the lighting device driving power supply 1 can be modified according to actual requirements, and the present invention is not limited to this design. As shown in FIG. 5, the lighting device driving power supply 1 includes a first terminal P1, a second terminal P2, a rectification module 10, a first energy storage module 11, a second energy storage module 12, a switch module 14, and a third energy storage module 13.

The first terminal P1 and the second terminal P2 are connected to the power grid. The rectification module 10 is a full-wave rectifier BD. The two input ends of the full-wave rectifier BD are connected to the first terminal P1 and the second terminal P2, respectively, while the two output ends of the full-wave rectifier BD are connected to the first node N1 and the second node N2, respectively.

The first energy storage module 11 is connected to the rectification module 10. The first energy storage module 11 includes a first inductor L1 and a first diode D1. The anode of the first diode D1 is connected to the first node N1, and the cathode of the first diode D1 is connected to one end of the first inductor L1. The other end of the first inductor L1 is connected to the third node N3.

The second energy storage module 12 is connected to the rectification module 10, the first energy storage module 11, and the light source LS. The second energy storage module 12 includes a first capacitor C1 and a second diode D2. The anode of the second diode D2 is connected to the first node N1, and the cathode of the second diode D2 is connected to one end of the first capacitor C1 and the fourth node N4. The other end of the first capacitor C1 is connected to the second node N2.

The switch module 14 is connected to the rectification module 10, the first energy storage module 11, and the second energy storage module 12. The switch module 14 is a transistor M1 (MOSFET). The source of transistor M1 is connected to the second node N2, and the drain of transistor M1 is connected to the third node N3.

The third energy storage module 13 is connected to the first energy storage module 11, the second energy storage module 12, the switch module 14, and the light source LS. The third energy storage module 13 includes a second inductor L2 and a third diode D3. The cathode of the third diode D3 is connected to the fourth node N4, and the anode of the third diode D3 is connected to the third node N3 and one end of the second inductor L2.

The light source LS includes a light-emitting diode LD. The anode of the light-emitting diode LD is connected to the fourth node N4, and the cathode of the light-emitting diode LD is connected to the other end of the second inductor L2.

The above elements are similar to those in the previous embodiment and will not be described in detail here. The difference between this embodiment and the previous embodiment, the lighting device driving power supply 1 of this embodiment further includes a voltage stabilization module 15. The voltage stabilization module 15 is connected in parallel with the light source LS. The voltage stabilization module 15 includes a second capacitor C2. The voltage stabilization module 15 achieves voltage stabilization effect, enhancing the performance of the lighting device driving power supply 1.

Similarly, when the switch module 14 is turned on, the rectification module 10 charges the first energy storage module 11, the second energy storage module 12, and the third energy storage module 13.

When the switch module 14 is turned off, the first energy storage module 11 and the second energy storage module 12 form the first closed loop, while the third energy storage module 13 and the light source LS form the second closed loop. Specifically, the first energy storage module 11 discharges to generate the first current, and the first current charges the second energy storage module 12 and forms the first closed loop. The third energy storage module 13 discharges to generate the second current, which flows through the light source LS and forms the second closed loop.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the lighting device driving power supply includes a rectification module, a first energy storage module, a second energy storage module, a switch module and a third energy storage module. The rectification module is connected to a power grid. The first energy storage module is connected to the rectification module. The second energy storage module is connected to the rectification module, the first energy storage module, and a light source. The switch module is connected to the rectification module, the first energy storage module, and the second energy storage module. The third energy storage module is connected to the first energy storage module, the second energy storage module, the switch module, and the light source. When the switch module is turned on, the rectification module receives an input voltage from the power grid to output a rectified voltage to drive the light source and charge the first energy storage module, the second energy storage module, and the third energy storage module. When the switch module is turned off, the first energy storage module and the second energy storage module form a first closed loop, while the third energy storage module and the light source form a second closed loop. Via this dual closed-loop mechanism, the driving power supply charges the second energy storage module via the first closed loop when the switch module is turned off and drives the light source via the second closed loop. Thus, the rectification module can remain in on state even when the switch module is turned off, such that the lighting device driving power supply can achieve a high power factor. Additionally, this mechanism effectively prevents increased harmonic currents, thus avoiding pollution of the power grid.

Also, according to one embodiment of the present invention, the lighting device driving power supply charges the second energy storage module via the first closed loop when the switch module is turned off. In this way, the second energy storage module can effectively prevent voltage surges caused by sudden changes in the input voltage. Consequently, the lighting device driving power supply prevents light source flicker caused by voltage surges. Thus, the lighting device driving power supply can provide anti-flicker function and achieve high efficiency.

Further, according to one embodiment of the present invention, the driving power supply charges the second energy storage module via the first closed loop when the switch module is turned off. Therefore, the second energy storage module can effectively prevent voltage surges caused by sudden changes in the input voltage. As a result, the lighting device driving power supply meets the requirements for wide voltage input, such that the lighting device driving power supply can be more comprehensive in application and meet the requirements of different applications.

Moreover, according to one embodiment of the present invention, the lighting device driving power supply can be realized via simple circuit design without the need for costly controllers or other specialized circuit components. As a result, the cost of the lighting device driving power supply is significantly reduced while maintaining excellent performance. Therefore, the lighting device driving power supply can conform to actual requirements.

Furthermore, according to one embodiment of the present invention, the lighting device driving power supply is designed with simplicity, achieving the desired performance while reducing costs. This simplicity ensures high practicality, meeting the diverse needs of different users and aligning with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device driving power supply capable of forming dual closed loops, comprising:
a rectification module connected to a power grid;
a first energy storage module connected to the rectification module;
a second energy storage module connected to the rectification module, the first energy storage module, and a light source;
a switch module connected to the rectification module, the first energy storage module, and the second energy storage module; and
a third energy storage module connected to the first energy storage module, the second energy storage module, the switch module, and the light source;
wherein when the switch module is turned on, the rectification module receives an input voltage from the power grid to output a rectified voltage to drive the light source and charge the first energy storage module, the second energy storage module, and the third energy storage module, wherein when the switch module is turned off, the first energy storage module and the second energy storage module form a first closed loop, while the third energy storage module and the light source form a second closed loop.

2. The lighting device driving power supply capable of forming dual closed loops as claimed in claim 1, wherein when the switch module is turned off, the first energy storage module discharges to generate a first current, and the first current charges the second energy storage module and forms the first closed loop, and the third energy storage module discharges to generate a second current, and the second current passes through the light source and forms the second closed loop.

3. The lighting device driving power supply capable of forming dual closed loops as claimed in claim 1, wherein the first energy storage module comprises a first inductor.

4. The lighting device driving power supply capable of forming dual closed loops as claimed in claim 1, wherein the second energy storage module comprises a first capacitor.

5. The lighting device driving power supply capable of forming dual closed loops as claimed in claim 1, wherein the third energy storage module comprises a second inductor.

6. The lighting device driving power supply capable of forming dual closed loops as claimed in claim 1, wherein the light source is a light-emitting diode or a light-emitting diode array.

7. The lighting device driving power supply capable of forming dual closed loops as claimed in claim 1, further comprising a voltage stabilization module connected to the light source in parallel.

8. The lighting device driving power supply capable of forming dual closed loops as claimed in claim 7, wherein the voltage stabilization module comprises a second capacitor.

9. The lighting device driving power supply capable of forming dual closed loops as claimed in claim 1, wherein the switch module is a metal-oxide-semiconductor field-effect transistor or a bipolar junction transistor.

10. The lighting device driving power supply capable of forming dual closed loops as claimed in claim 1, wherein the rectification module is a bridge rectifier.
